(19) United States
(12) Patent Application Publication
(10) Pub. No.: US 2007/0272662 A1
(43) Pub. Date: Nov. 29, 2007

(54) Method and Device for Cleaning an Electric Arc Welding or Cutting Burner and Electric Arc Welding or Cutting Device

(76) Inventors: Jorg Faber, Wetzlar-Dudenhofen (DE); Ingo Frischkorn, Buseck (DE)

Correspondence Address: BLAKELY SOKOLOFF TAYLOR & ZAFMAN, 1279 OAKMEAD PARKWAY, SUNNYVALE, CA, 94085-4040, US

(21) Appl. No.: 10/592,547

(22) PCT Filed: Mar. 11, 2005
(86) PCT No.: PCT/EP05/02617

§ 371 Date: Jun. 15, 2007

(30) Foreign Application Priority Data
Mar. 12, 2004 (DE) 10 2004 012 609.7

(51) Int. Cl. B23K 9/02

(52) U.S. Cl. 219/121.36

(57) ABSTRACT

The invention relates to a method for cleaning an electric arc welding or cutting device, particularly the functional parts thereof such as a gas nozzle, tuyère connection and the like, and removing impurities therefrom. The burner is impinged upon by a cold jet means from the media supply side thereof, wherein the temperature difference Δ_{T} between the jet means and the functional parts of the burner is>80 K and the temperature of the functional parts of the burner is above ambient temperature.

The invention relates to a method for cleaning an arc welding or arc cutting torch, particularly its functional parts, such as gas nozzle, nozzle holder, gas nozzle bore and the like from impurities, such as for example weld spatters, wherein the torch is supplied with a blast medium from the side of the medium supply. The invention furthermore relates to a device for arc welding or arc cutting as well as an arc welding or arc cutting torch.

During the welding process weld spatters can't be avoided, which contaminate inside and outside of the gas nozzle, but also further functional parts of the torch such as nozzle holder, gas nozzle bores and the like and have to be removed from time to time.

For this purpose, both mechanical procedures and contactless procedures are known which in particular are used for torches which are to be placed in automatically working systems, so called robot torches.

For mechanical cleaning, such as for example described in DE 296 17 810, a rotating tool is used which is moved in the gap between contact nozzle and gas nozzle. Disadvantageously, this mechanical processing may result in the surfaces of the gas nozzle to be damaged and roughened by the applied tool, such as molding cutter, knife or brushes, which, as a consequence, may lead to an even quicker and increased contamination. Furthermore, the tools have to be adapted to the respective torch geometry which is connected with corresponding requirements.

From WO 02 49794 A1, a contactless procedure is known, wherein a cold blast medium of CO₂ pellets and compressed air is used. For this purpose, the stream of compressed air is directed to a certain section of the torch which is to be cleaned by means of jet nozzles, wherein the jet simultaneously carries out a rotational movement around the central longitudinal axis of the torch in order to cover the whole section which is to be cleaned. It is disadvantageous, however, that, just as similarly to the mechanical cleaning procedures, especially automatically working systems, such as for example robot torches, have to be separately moved to the cleaning station. The change in the position of the torch required for the cleaning procedure leads to a corresponding interruption of the working process. Furthermore, it may be necessary to blow the impurities out of the torch chamber encompassed by the gas nozzle in a separate processing step by means of compressed air.

A cleaning device for welding torches is known from US 2003/0024917, wherein the gas nozzle to be cleaned is supplied with dry ice pellets. For that purpose, the device has a cleaning box to which the torch is docked with its gas nozzle to be cleaned and which is connected to a CO₂ box in order to generate dry ice pellets. After the impurities on the gas nozzle have been removed by means of dry ice pellets and the torch has been supplied with compressed air in order to blow through the gas nozzle from the side of the medium supply, the cooling medium used and the loosened welding splashes are to be removed by means of a vacuum connection. Subsequently, the cleaning container is supplied with compressed air for cleaning and drying purposes. In addition to the disadvantages described before, the constructive efforts for the known device are comparatively high.

Finally, from EP 0 074 106 A1 it is known to supply a robot torch with compressed air by means of its gas connection to the torch body in order to thus blow air through the gas nozzle from the inside. The low cleaning effect is a disadvantage of this known procedure.

Thus, the invention is based on the objective to provide a method for cleaning arc welding or arc cutting torches, in particularly the functional parts thereof, which leads to an effective cleaning without major interruption of the working cycle of the torch. Besides, it is the objective of the invention to provide an arc welding or arc cutting torch or corresponding system designed to fulfill these requirements.

In order to solve the objective, the invention basically provides the use of a cold blast medium, wherein the difference in temperature Δ_{T} between the blast medium and the functional parts of the torch to be cleaned is>80 K and the temperature of the functional parts of the torch is above room temperature.

According to the invention, the cold blast medium is blown from within on the surface of the torch to be cleaned, particularly its functional parts such as the gas nozzle, the nozzle holder or for example the gas nozzle bores. Thus, the impurities sticking to the surface area of the functional parts of the torch shrink due to quick cooling, so called shock freezing, by means of which the impurities are loosened from the torch chamber and carried away thanks to the blast medium stream from behind.

Since there's no need to move the torch to be cleaned to a separate station, the total cleaning time is significantly shorter. Furthermore, no independent cleaning device has to be provided. Furthermore, it was surprisingly found that by transporting the cold blast medium through the torch body, the undesired brittleness of the torch body or respectively its components, particularly its plastic parts or electronic components was avoided.

For the supply with the cold blast medium, the present supply devices for the shielding gas or the cutting gas of the respective torch may be used during the cleaning cycle. It is to be noted that separate supply devices in the torch may also be provided.

According to a first, preferred embodiment of the invention, the provided temperature of the blast medium is of<77 K. Thanks to these temperatures for the blast medium, the torch may particularly quickly and effectively cleaned.

According to a further embodiment of the invention, the use of a cold blast medium mixture consisting of a carrier medium and particles in solid or liquid phase is provided. The cleaning effect can be influenced by the kinetic energy of the particles.

Advantageously, compressed air and/or CO₂ are used as carrier medium which is practically at disposition in all automated systems, particularly as far as compressed air is concerned.

It is particularly advantageous if dry ice, dry ice pellets and/or CO₂ snow are used as particle. Therein, the cleansing effect is additionally enhanced by the mechanical energy of the dry ice pellets or respectively of the CO₂ snow subsequent to a contact with the surface to be cleaned. Due to the sublimation of the CO₂ with a seven hundredfold increase in volume, there's an additional rinsing effect such that the impurities are quickly and effectively removed from the torch chamber encompassed by the gas nozzle.

According to a special embodiment of the invention, it is provided that the blast medium is pressurized CO₂ in liquid form. The liquid CO₂ relaxes immediately after leaving the supply device under pressure. Due to the evaporative cooling, the CO₂ is cooled down to below 210 K so that it enters the torch chamber encompassed by the gas nozzle in form of dry snow. This snow blast procedure is particularly effective, especially as far as the CO₂ consumption is concerned. Furthermore, it is significantly less abrasive compared to cleaning methods using CO₂ pellets. Moreover, it can be realized more easily, especially as far as automation is concerned, since no pellets have to be charged which has cost saving effects regarding purchase and maintenance of the cleaning device.

As far as the device is concerned, the objective is solved by providing the torch with at least one supply device for conveying a cold blast medium or a cold blast medium mixture into the torch chamber encompassed by the gas nozzle. For the supply of the cold blast medium or cold blast medium mixture, either the already present supply devices for the protective or cutting gas of the torch may be used or alternatively it is also be possible to provide the torch with separate supply devices.

Preferably, the supply of the cold blast medium or respectively of the cold blast medium mixture takes place within the area of the torch, particularly the swan neck or the torch body, for example within the area of the connector for the hose. Alternatively, the supply of the cold blast medium or respectively cold blast medium mixture may obviously also take place in the area of the hose itself.

The arc welding or arc cutting torch according to the invention is either a manually torch or a torch for automated welding, for example at the hand of the welding robot.

In the case of a welding or cutting torch for a manipulator it is provided that the supply with the cold blast medium or respectively cold blast medium mixture takes place within the area of or by means of the holding device of the manipulator for the torch.

According to an alternative embodiment of the invention, the holding device or the torch is provided with a coupling for supplying cold blast medium or respectively blast medium mixture, which might be connected to a counter coupling part in the flow path of the cold blast medium or respectively blast medium mixture. For cleaning, the torch welder is moved with its coupling towards the counter coupling part of the supply device for the blast medium by means of the manipulator. When a valve is opened the blast medium can stream into the torch or respectively into the torch chamber to be cleaned. Thus, it is also possible that only by coupling the coupling piece to the counter coupling part the blast medium is introduced into the torch. In this embodiment, no direct supply lines for conveying the cold blast medium to the torch are necessary which under certain circumstances might limit the elbow room of the manipulator during welding or cutting.

The invention also covers a device for arc welding or arc cutting with a welding or cutting torch, a welding device or respectively a welding system, a control device and supply lines connecting the torch and the welding device or respectively the welding system, wherein the control device is designed for introducing and interrupting the supply the cold blast medium or respectively blast medium mixture. Therein, the already present control unit of the welding device or respectively system is advantageously used for the introduction of the cold blast medium or respectively blast medium mixture.

Particularly in case of a manually operated torch its manual piece is provided with an input or confirming unit for the introduction and interruption of the supply with cold blast medium or respectively blast medium mixture which is connected to the control unit. By activating the input or confirming device the welding process is interrupted via the control device and the torch is cleaned due to the supply with cold blast medium or blast medium mixture from the side of the medium supply of the torch. Thus, the welder doesn't have to move the torch towards a separate cleaning station.

The torch just has to be turned away from the weld, such that the contamination within the torch chamber is peeled off and can be discharged.

If the cold blast medium is led through the supply lines of the torch, particularly the hose, the invention provides that the connection at the side of the device or the system is designed for the supply with cold blast medium or respectively cold blast medium mixture, by which the torch can be more easily connected to all necessary supply devices, lines and the like.

Further objectives, disadvantages, features and possible applications of the presents invention result form the following description of an exemplary embodiment by means of the drawings. Thus, all the features described and/or illustrated in the pictures form, either alone or in any useful combination, the object of the present invention, also independently from their summary in the claims or independent claims.

They show:

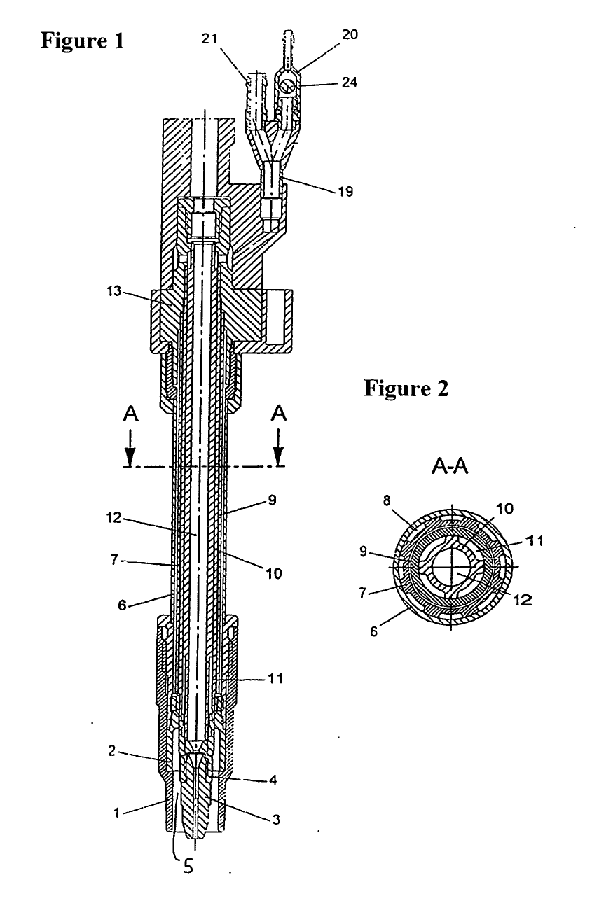

FIG. 1 a longitudinal cut of a possible embodiment of an arc welding or arc cutting torch suited for the cleaning method according to the invention

FIG. 2 a cross cut of the torch along the line A-A according to FIG. 1,

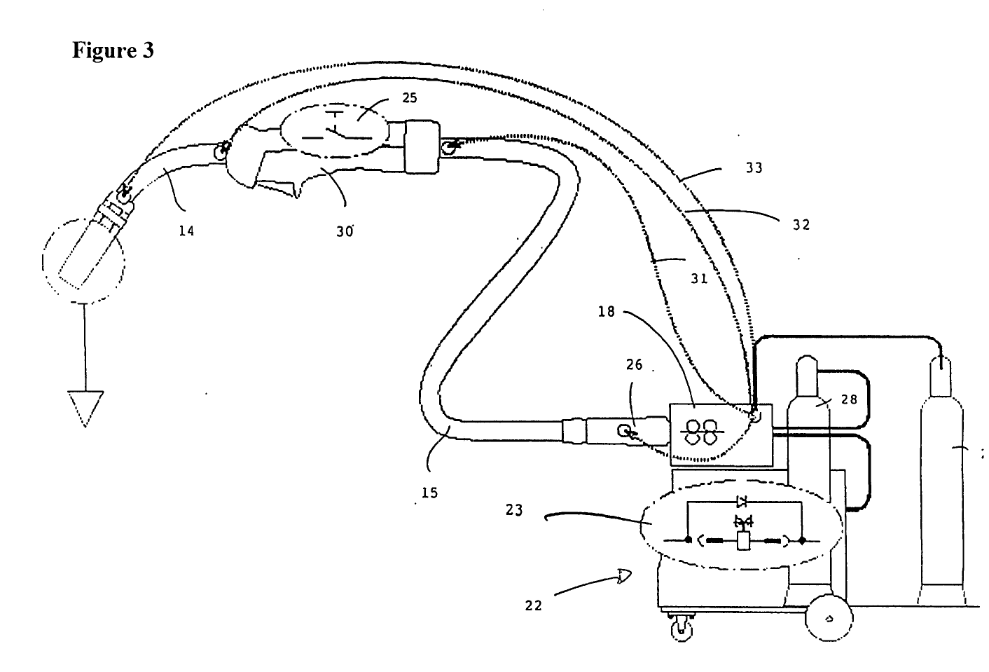

FIG. 3 a possible embodiment of a device for arc welding or arc cutting with manually operated torch, hose and welding device and

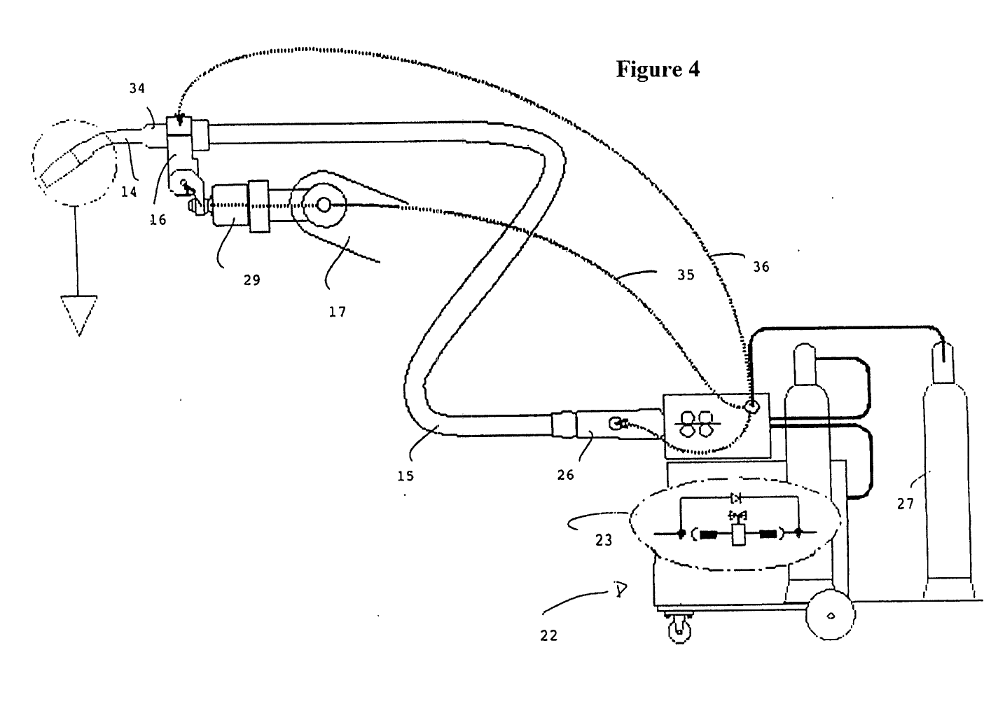

FIG. 4 a possible embodiment of a device for arc welding and arc cutting with a torch situated at the arm of a manipulator with hose and welding device.

The arc welding torch according to FIGS. 1 and 2 disposes of a gas nozzle 1 which in the exemplary embodiment here displayed is provided with a splatter guard 2 at the inside. A contact tip 3, which is put on a contact tip holder 4 at the end of an inner profile tube or torch tube 10, is centrically arranged on the longitudinal axis of the torch within the gas nozzle 1. The profile tube 10 runs in the center of the torch from the contact tip holder 4 into the torch body 13, wherein in the inner chamber 12 of the torch tube 10 a wire electrode (not shown), with a spirally wound wire guide surrounding it, is arranged.

As can be particularly seen in FIG. 2, the inner profile tube 10 has longitudinal grooves 11 distributed on its outer circumference, serving as gas channels for the protective gas and surrounded by the insulation 9. The exterior profile tube 7 is coaxially arranged around the insulated inner tube 10 which is again surrounded by an exterior tube 6 and forms the channel system 8 for the liquid cooling.

This coaxial profile tube system extends into the torch body 13 which at its rear front side disposes of an electrically insulating sealing 17 between a connector 22 for a hose 15 and the actual torch body. The grooves 11 of the inner profile tube 10 end in the connector 22 of the torch body 13 in a ring shaped chamber in the flow path of the inside of the branch 16. The connectors for the cooling water are indicated with 14 and 15.

In the exemplary embodiment which is displayed here, the channels 11 for the protective gas are simultaneously used for the introduction of the cold blast medium or respectively blast medium mixture for cleaning the torch chamber 5 encompassed by the gas nozzle 1 or respectively the functional parts arranged therein.

In the exemplary embodiment, the protective gas and blast medium or respectively blast medium mixture are combined at the end of the hose before reaching the actual torch body 13. The reference sign 19 stands for the torch connection, 20 for the connection for the protective gas line and 21 for the connection for the blast medium. A return valve 24 arranged in the connector 20 for the protective gas line automatically blocks the protective gas line 20 in case of a pressure charge from the area of the supply line 21. Once the blast medium shoots through the blast medium line 21, the return valve 24 in the protective gas line 20 closes and prevents the protective gas from being mixed with the blast medium mixture in this area.

The exemplary combination of protective gas and blast medium shown in FIG. 1 is only one exemplary embodiment and may also be constructively altered while the principle of the combination is maintained. The blast medium and protective gas are preferably combined at the end of the hose 15, directly before reaching the torch body 13. Obviously, other embodiments are possible as well, for example with separate supply lines for the blast medium in the torch and if necessary in the hose.

In the exemplary embodiment here displayed the gas channels 11 serve for the supply with blast medium during the cleaning phase of the torch. Since the outlets 25 in the area of the gas nozzle 1 allow a regular outlet of the protective gas, a regular outlet of the cold blast medium, particularly of the CO₂ snow along the torch longitudinal axis is achieved. At first, the CO₂ snow radially leaves the grooves of the gas channels 11 or respectively of the gas bores 25 and thus reaches the inner wall of the gas nozzle 1 or respectively the splatter guard 2 and the other functional parts. By the quick cooling in the way of quick freezing, the impurities, particularly the weld splatters, shrink, wherein the particles in solid phase (dry ice) contemporaneously have the effect of a mechanical cleaning due to their kinetic energy when a contact with the surface to be cleaned is made due to the sublimation of the CO₂ with a seven hundredfold increase in volume there's an additional rinsing effect such that the impurities are optimally removed from the gas nozzle chamber 5.

The cleaning with the help of dry ice can be constructively realized in a particularly easy way by using pressurized CO₂ in liquid form as blast medium, which is arranged in pressure bottles 27 in the area of the welding device 22, sometimes on a collective carriage, as can be for example seen in FIGS. 3 and 4. In this procedure, the CO₂ relaxes immediately after leaving the pressurized CO₂ bottle 27. By the evaporative cold, the liquid CO₂ is cooled to a temperature of below 210 K so that it can enter the torch chamber 5 in form of dry snow.

The device for arc welding displayed in FIG. 3 disposes of a manually operated torch 30 which is connected to the welding device 22 by means of a hose 15 and a device connector 26. The welding device 22 disposes of a control device 23 for the adjustment of the welding parameters. Furthermore, the welding device 22 has a wire feed system 18 for extending the wire electrode to the torch 30. The protective gas is arranged in a protective gas bottle 28 the cold blast medium or respectively CO₂ in the bottle 27.

As can be seen in FIG. 3, the cold blast medium might be led to the torch 30 in different ways for example via the device connector or respectively the plug and from there via the hose 15 to the torch 30. It is also possible to provide a separate line for the cold blast medium via a supply line 31 outside of the hose 15, wherein it is connected at the torch body 13. Furthermore, the cold blast medium may be introduced via a separate supply line 32 within the area of the swan neck 14, for example at the beginning of the swan neck or via a supply line 33 directly in the area of the free end of the swan neck 14.

The manually operated arc welding torch 30 furthermore disposes of an activation unit 25 at the manual piece, by means of which the control device 23 may be addressed in order to interrupt the welding process and to allow a supply with cold blast medium from the bottle 27.

FIG. 4 shows a so called robot torch, which is held at the hand or the arm of a robot 17 by means of a holding device 16. The holding device 16, on its part, is fixed at a collision guard 29. In that case, the cold blast medium might also be introduced via the device plug 26 via separate supply lines 35, 36 into or by means of the holding device 16.

It is also possible to provide the holding device 14 or the torch body 13 with a coupling which interacts with a counter coupling part arranged at the end of the supply line 36 for the cold blast medium. Thus, the hitch at the welding torch 34 or respectively at the holding device 16 can be brought into a coupling position with the counter coupling part of the supply line 36 for the cold blast medium by means of a movement of the robot 17, so that the cold blast medium can stream into the torch chamber 5. Anyway, no separate, independent cleaning devices for cleaning the torch 34 have to be provided.

### REFERENCE SIGNS

1. Gas Nozzle
2. Splatter Guard
3. Contact Tip
4. Contact Tip Holder
6. Outer Pipe
7. Profile Pipe
8. Channel System for Liquid Cooling
9. Insulation
10. Profile Pipe
11. Grooves, Supply Devices
12. Inner Chamber
13. Torch Body
14. Connector for Cooling Water
15. Connector for Cooling Water
16. Branch
17. Sealing
18. Wire Feed
19. Torch Connection
20. Connection, Supply Device
21. Connection
22. Connective Part
24. Return Valve
25. Outlet
26. Connection, Plug
27. Supply Device, CO₂ bottle
28. Protective Gas Bottle
29. Collision Protection
30. Torch
31. Supply Line
32. Supply Line
33. Supply Line
34. Robot Torch
35. Supply Line
36. Supply Line

1. Method for cleaning an arc welding torch or an arc cutting torch, particularly its functional parts, such as gas nozzle (1), nozzle holder (2) and the like, from impurities, wherein the torch is supplied with a blast medium from the medium supply side,
characterized in that a cool blast medium is used, wherein the difference in temperature D_{T} between the blast medium and the functional parts to be cleaned is>80 K and the temperature of the torch's functional parts is above room temperature.

2. Method according to claim 1, wherein the temperature of the blast medium is<77 K.

3. Method according to claim 1, wherein a mixture of cool blast medium, consisting of a carrier and particles in solid or liquid phase, is used.

4. Method according to claim 3, wherein compressed air and/or CO₂ are/is used as carrier medium.

5. Method according to claim 1 wherein dry ice, dry ice pellets and/or CO₂ snow are used as particles.

6. Method according to claim 1 wherein pressurized CO₂ in liquid form is used as blast medium.

7. Arc welding or arc cutting torch, wherein at least one supply device (11) is provided for conveying a cold blast medium or cold blast medium mixture to a torch chamber (5) surrounded by the gas nozzle.

8. Arc welding or arc cutting torch according to claim 7, wherein the supply with the cold blast medium or respectively the mixture of cold blast medium takes place in the area of the torch (30), particularly the swan neck (14) or the torch body (13) or within the area of its supply lines, particularly the hose (15).

9. Arc welding or arc cutting torch according to claim 7, particularly for welding by means of a manipulator (17), particularly a welding robot, wherein the torch (34) is held at the manipulator (17) by means of at least one holding device (16), characterized in that the cold blast medium or respectively the blast medium mixture is supplied place within the area of or via the holding device (16).

10. Arc welding or arc cutting torch according to claim 9, wherein the holding device (16) or the torch (34) is provided with a coupling which can be connected to the counter coupling part in the flow path to the supply device (27) for the cold blast medium or respectively blast medium mixture.

11. Device for arc welding or arc cutting with a welding or cutting torch, a welding device (22) or respectively a welding system, a control device (23) and supply lines (15) connecting the torch (30, 34) and the welding device (22) or respectively welding system, wherein the control device (23) for starting and interrupting the supply with cold blast medium or respectively blast medium mixture.

12. Device according to claim 11, wherein the torch (30) has an input and/or confirmation device (25) for the introduction and interruption of the supply of the cold blast medium or respectively blast medium mixture which is connected to the control device (23).

13. Device according to claim 11 wherein the connector (26) on the side of the device or respectively of the system is designed for the supply lines (15) for the supply with cold blast medium or respectively blast medium mixture.
